(19) United States
(12) Patent Application Publication
(10) Pub. No.: US 2015/0101375 A1
(43) Pub. Date: Apr. 16, 2015

(54) ANAEROBIC DIGESTION SYSTEM FOR HOUSEHOLD ORGANIC WASTES

(71) Applicant: Vattackatt Balakrishnan Manilal, Thiruvananthapuram (IN)

(72) Inventor: Vattackatt Balakrishnan Manilal, Thiruvananthapuram (IN)

(73) Assignee: Council of Scientific and Industrial Research, New Delhi (IN)

(21) Appl. No.: 14/382,401

(22) PCT Filed: Mar. 11, 2013
(86) PCT No.: PCT/IN2013/000140

§ 371 Date: Sep. 2, 2014

(30) Foreign Application Priority Data
Mar. 19, 2012 (IN) 799/DEL/2012

(51) Int. Cl. C05F 17/02

(52) U.S. Cl. CPC C05F 17/0223; C05F 17/0241
USPC 71/10; 435/290.2; 435/290.1

(57) ABSTRACT

The present invention provided a compact anaerobic digestion system to converts household waste biomass materials to methane rich biogas and concentrated compost slurry of about 9 to 40% solids for agriculture soil applications. The horizontal anaerobic digester vessel comprising a horizontal vessel provided with insulation and preferably cylindrical at the bottom, fitted inside of the said vessel is at least one shaft with 4-100 radial or horizontal or diagonal baffles at equal distribution, and attached with a handle or wheel outside the vessel to rotate the shaft from outside, the said vessel being provided with minimum of one port at one end for introducing the raw biomass wastes and another set of ports for discharging stabilized wastes at the opposite end, and having one valve-controlled gas port of above the level of the said port for discharging stabilized wastes, a small hand operated shredder coupled to the digester vessel for shredding/cutting/crushing large and hard solids such as bones to get particles preferably lesser than 10 mm sizes. The waste falls inside the digester and gets mixed slowly while being fed by rotating the handle attached to a shaft having baffles inside the digester.

The following specification particularly describes the nature of this invention and the manner in which it is to be performed.

### FIELD OF THE INVENTION

This invention relates to an improved anaerobic digester for household organic wastes. More particularly present invention provides a convenient system containing anaerobic microorganisms that facilitates digesting of household organic wastes with high solids and less moisture. The digester of this invention enables the anaerobic digestion of biodegradable wastes such as household wastes, spoilt food, crop biomass, animal wastes, mixture of plant and animal wastes, garbage, agriculture wastes, water weeds, garden cuttings, etc. for releasing nutrients and micronutrients, stabilized digestate and methane rich biogas at source of generation. This invention also helps to produce biofuel from biomass for regular household use. The invention also facilitates compounding of anaerobically digested sludge with lignocellulosic wastes of biological origin for detaining the nutrients and partitioning it to soil slowly.

### BACKGROUND TO THE INVENTION

Wastes generated from household activities add major bulk to the municipalities and quite often ends up in dumping partially treated or untreated, and leading to serious environmental pollution in most of the world. Management of such biodegradable wastes is a serious problem because of the difficulty in exclusive collection, storage and transportation to the treatment plants without putrefaction. The odour and leacheate generated from the putrescible components of the wastes biomass are hard to control during the existing methods of management and treatment. This is typically observed in the common and widely used aerobic composting plants. The generally used, comparatively less expensive windrow composting method in small and large scales has several drawbacks and is not possible to adopt at house level in urban and semi-urban areas where there is no land availability. The alternate anaerobic digestion and stabilization or composting of biodegradable wastes is found as a suitable method especially where climatic conditions are moderate or under insulated conditions, but practicing of this at house levels is difficult.

Currently used anaerobic plants of small or family sizes are working with large volumes of water where the solids may be fed directly or after grinding in some cases. Invariably such plants discharge voluminous quantities of partially and undigested organic matters, of less than 5% solids. They are originally the floating dome and fixed dome models (Lichtman, 1983, VITA, Virginia, USA; Leach, 1987, Biomass 12, 155-184). Management of such digesters is extremely difficult due to the voluminous discharge of partially digested effluents with malodour, and regular requirement of fresh water. Fats, the significant ingredient in the food wastes are hardly decomposed in such widely used house level digesters/commonly built biogas plants and become serious source of pollution and odour nuisance. In order to avoid problems of the fats and similar materials which are required to be separated from wastes before loading to currently used systems and treated aerobically or buried in soil. Similarly, the solid biomasses are not fully degraded and mineralized unless they are mechanically ground and loaded to the conventional biogas plants. Other conventional anaerobic biomass composting by soil burial is, though unsuitable for collecting methane or controlling methane emission, not possible where wastes generation are from houses at small strips of lands. The recently introduced methods of high solids anaerobic digestion (HSAD) are designed to operate at large scales after collection, segregation and preprocessing of organic wastes. The HSAD are proposed to process digestion plants 30,000 to 50,000 tons of source separated organics of MSW per year. In addition the utilization of the end products, biogas and stabilized of HSAD compost also need to be transported and placed in distribution for marketing. These high solids digestion methods have all problems of other centralized treatment plants except their merits to decompose the solids without water dilution. Quite often the digestate or compost and biogas need further processing for the effective offsite utilization. As a result the net gain from such centralised process becomes unattractive in terms of energy yield and compost value after meeting all such expensive handling operations. Odour pollution during collection, segregation and transportation of wastes is highly objectionable and quite often unmanageable in densely populated areas and remains unsolved in such systems.

### DISCUSSION OF THE PRIOR ART

The current digestion methods adopted for the stabilization of biodegradable wastes are aerobic or anaerobic or a combinations thereof. Properly adopted aerobic methods are destined to get complete stabilization of biodegradables in solid wastes, but employment of such methods alone, usually applied in many places are either costly or ineffective. One such case is the intolerable malodour and operations in the absence of smell control devices cause terrible nuisance in such treatment plants and surrounding areas.

One of the most appropriate primary processing methods for the stabilisation of biodegradable wastes is the anaerobic digestion which is mediated by microorganisms. The anaerobic process to produce methane from wastes biomasses of plant, animal and kitchen wastes are well known (U.S. Pat. Nos. 5,90,931; 5,863,434; 5,821,111; 5,746,919, 5,626,755; 5,567,325; 5,143,835; 4,735,724; 4,503,154). Such microbial methods have been in use and available from wastes treatments. This principle is possible to apply in varied scales from small household scales to massive scales for varied biodegradable materials, but needs to have systems of suitable design.

Anaerobic digestion of solid wastes to remove biodegradables has been studied across the world (De Baere 1999, Water Science Technology, 41 457-462). Most of such developments to improve digestion of solids and biomethanation are targeted to operate at large scales. These developments are complex and not feasible in household scales. Improved biomethanisation of solid wastes is reported recently in the laboratory and field experiments by circulating leachates between new and anaerobically stabilized bed (Lai et al., 2001, Nopharatana et al., 2002). Leach bed anaerobic digestion model for unsorted municipal solid wastes was found useful to obtain methane yield 75% of the ultimate biochemical methane potential of the waste loaded (P. Silvey, et. al 2000).

Improved digestion of the wastes containing cellulosic materials through thermo-chemical treatments is described in the patent GB0360922A entitled “Improvements in and relating to the treatment of cellulosic materials”. Chemical addition and thereafter neutralization of the material is recommended in this during the treatment. In another treatment process given in the patent CN1587214A deals with anaerobic method to bamboo fibre processing wastes. The materials are primarily treated with ammonium bicarbonates and zinc sulfate and the water stream resulted from the treatment is inoculated with microbial population to methane containing gas.

Dale and Malstrom 1981 (U.S. Pat. No. 4,274,838) have developed an anaerobic digester for organic wastes such as animal manure which is fed to an elongated tank. Several systems and facilities are provided in the tank to prevent scum formation and controlling the slurry movement and gas collection. This system basically works with the material pre-processed in the stomach of cattle and in large capacity. The above development is an improved method of McDonalds 1978 (U.S. Pat. No. 4,100,0023) and Albrs 1979 (U.S. Pat. No. 4,169,048) and others (U.S. Pat. No. 4,511,370, 1985). Some batch digestion systems are also discussed in certain cases where plant biomass is collected and treated to produce methane (Abbasi et al, 1990, Biological Wastes 34, (4) 359-366).

The Valorga process developed in 1981 uses a method to digest the biomass in single stage but is given a steam treatment after rejecting the non-biodegradable. This is workable as a centralized system after collecting and bringing the biomass to the plant site.

Another method for the anaerobic decomposition of organic wastes and biogas generation is explained by Smis et al. 1995 (U.S. Pat. No. 5,389,258) in which solids or semi solids are fed to a reactor at the top and fermented liquor is collected at the bottom and mixed the solids with fresh solids using pumps and elaborate systems.

In some of the methods of organic wastes anaerobic digestion require aqueous medium in large proportion (U.S. Pat. No. 5,637,219 Robinson, et al. 1997, U.S. Pat. No. 5,746,919 Dague, et al. 1998). Such systems are typically useful for the biodegradables in dissolved or easily hydrolysable forms. The suspended solids loaded are not fully decomposed in such systems and therefore not suitable for the anaerobic digestion of solid wastes biomass. The improper handling of voluminous amount of discharges, incompletely digested biomasses are causing not environmental problems but yielding less amount of methane also.

Two phase digestion system has been proposed in the U.S. Pat. No. 5,500,123, 1996. A modified two-phasic high-rate digester has been reported for fibrous and semi-solid municipal solid waste by TERI (Tata Energy Research Institute). These processes consist of extracting a high COD (˜15,000-20,000 mg/I) organic leachate from the vegetable waste in an acidification reactor followed by treating the leachate in an up flow anaerobic sludge blanket (UASB) reactor. Treatment and disposal of the liquid is a serious problem in the process.

The U.S. Pat. No. 6,299,774, 2001 teaches anaerobic digestion system to recover energy, reduce pollution potential, and add value to organic waste such as animal manure in the In this animal manure is processed at low to high temperatures in batch, semi-continuous or continuous reactors. The process claims to make use of existing handling and storage equipment at the farm and requires minimal supervision and skill. It is claimed to produce high quality methane at low cost. The system advocates operation at high pressures preferably between 10 to 100 psi unlike the many other anaerobic digesters. The other requirement for operation includes preparation of the feed material as slurry.

Another High Solids Anaerobic Digestion (HSAD) available today is designed to operate with a capacity above 100 tons per day which are known to work with thermophilic bacterial consortium at around 55° C. (US Department of Energy's National renewable Energy Laboratory). It is not suitable to work at small scales.

An apparatus for treating wastewater and solid organic wastes was proposed by Cameraon in U.S. Pat. No. 5,633,163, 1997 which has an aerobic treatment chamber assembly with compost bed. Another system is discussed for biogasification of solid wastes with an anaerobic phased solid digester by Zhang & Zhang 2002 (U.S. Pat. No. 6,342,378), again an elaborate system unsuitable to operate in small scales.

In the U.S. Pat. No. 6,663,777B2 (2003) Schimel discloses an apparatus, system and process for anaerobic conversion of biomass, slurry to energy. This is a complex system has many process vessels and pumps and aimed to operate at large capacity.

The dry cycle anaerobic digester as described in the U.S. Pat. No. 7,144,507 B2 2006, and claims to produces little sludge. This is basically aimed to treat low solids as in wastewater.

The process of Gray and Suto (U.S. Pat. No. 7,410,583 B2) 2008 describes treatment of food wastes and other organic wastes to prepare waste slurry and anaerobic digestate, which requires several units and unit operations. This is also aimed to operate in large scales.

In the KOMPOGAS digestion process wastes containing high-solids is treated by thermophilic horizontal system which is fed regularly, mostly every day. Feed to this process is organic wastes from municipalities mostly originated from the food industry. In some cases, the biogas is upgraded to natural gas standards for use in vehicles or input to the natural gas network. However, the entire system is not aimed to work in the premises of individual houses with small amount of biomass solids.

Another digester apparatus claims to convert wet biomass materials to biogas in digestion unit operating at controlled temperature by feeding through a concentrator component. The biomass needs to be fed as slurry and the apparatus is controlled through a computer (U.S. Pat. No. 6,663,777 B2, 2003). This system is targeted to work as a large facility for biomass treatment.

A horizontal plug flow anaerobic system has been introduced by Linde-KCA in which wet and dry digestion of biomass works on both mesophilic and thermophilic processes. This two-stage process that initially treated aerobically and the hydrolysate is conveyed to the anaerobic through a conveyor system moved with internal rotor. Later the material is dewatered.

The anaerobic solids wastes treatment and energy generation so far reported work under the following condition/conditions.
Designs are mainly targeted for centralized treatment and require a chain process-collection in containers, transferring to larger containers, transporting to digester sites,
Preprocessing of the materials is required to meet the digester conditions,
Operations are energy intensive and complex to perform at the source of production such as house level,
Operation requires skilled man powers,
Requires high capital and maintenance costs as they are aimed at large scale operations,
System needs biogas energy utilization systems which also require capital investment and operation.
Digested compost requires further processing and marketing network.

There are many companies of small and large, and organizations in the country and outside that supply biogas plants. These commercial biogas plants are sized and scaled on the traditional models of biogas plants (KVIC or Deenbindu in India) initially developed for the generation of biogas from cattle dung (gober gas), basically to convert residuals of soluble organics in the excreta of animals to biogas. It has feed inlet and effluent outlet and gas collection dome either floating or fixed. This type of biogas plant is suitable to use for the treatment of preprocessed material like in the stomach of animals. The disadvantages of using these designs for household wastes biogassification and treatment as it is done currently the wastes materials are not effectively digested and converted to biogas in the case of cattle dung wastes. The solids and fats of the household wastes are incompletely digested and that resulted in the discharge of polluting, odourous, unmanageable effluents in large quantities. Moreover, these biogas plants are generally bulky and require fresh water addition during the wastes feeding. In tropical areas he biogas plant area supports breeding of mosquitoes and related vector borne diseases.

The inefficiency of commercial domestic biogas is obvious from certain reports. For example the evaluation report of the small scale biogas plants treating wastes in South India using one typical popularized make, ‘BIOTECH plant’ feeding on kitchen wastes (Nicholas Estoppey, Evaluation of small-scale biogas plants for the treatment of faeces and kitchen waste, eawag Aquatic Research 2010). In the above sample study a plant of 2000 litre capacity feeding 2.9 kg of wastes per day has been discharging 11.7 litres of effluent. According to the report the effluent discharged every day is watery and requires further treatment before disposal because of the heavy pollution load. Maximum methane content in the biogas is 65%. Such biogas plants have the Gas Production Rate (m3/m3 digester/day) of about 0.47.

Another popular make ARTI in India which is claimed as compact biogas plants, suggested to install 1000 litre to 1500 litres almost the same as recommended sizes by the BIOTECH make for a family of 3-5 members and it discharges around 15 litres of effluent every day. This means that such plants require additional water also for their operation. The efficiency is not different in this case too as the biogas composition and Gas Production Rate are the same as BIOTECH.

It is understood from the prior art that a suitable mechanism is not available for the complete digestion and stabilization of wastes biomass generated at houses, and which facilitates recovery of biogas energy and nutrients recycle for agriculture application at the source of generation. Further, the invention of the improved system provides a higher yield methane and well stabilized compost compared to other systems in the line. Still further, the need of a system for treating biodegradable wastes at the point of origin is highly relevant in the present context.

### SUMMARY OF INVENTION

It is therefore the primary object of the invention to provide a compact high solids anaerobic digestion system for wastes biomass and putrescibles from houses.

It is yet another object of the invention to decompose biodegradable organic wastes without preprocessing or pretreatments.

It is still another object of the invention to decompose biodegradable organic wastes under less water condition.

It is another object of the invention to produce methane rich biogas from wastes biomass through inexpensive microbial process.

It is still another object of the invention to decompose biodegradable organic wastes at the place of generation effectively and conveniently.

It is yet another object of the invention to use system which has high retention of wastes biomass for complete digestion in small volume.

It is another object of the invention to use system which requires no electricity for the production of methane rich biogas from wastes biomass.

It is yet another object of the invention to collect methane rich biogas produced for regular onsite use or further use.

It is another object of the invention to condition biodegradable organic wastes with a compact system for pollution free application in agriculture.

It is yet another object of the invention to release nutrients bound in biodegradable organic materials through anaerobic process.

It is still another object of the invention to produce soil conditioner with nutrients from organic wastes that improves moisture retention and air circulation qualities.

It is still another object of the invention to retain nutrients in an eco-friendly material for their slow release in soil applications.

It is still another objective of the invention to balance water content of the digested matters, compost for convenient handling and transportation.

It is still another object of the invention to control pollution from biodegradable organic matter such as household wastes, animals and birds wastes, weeds in land and water, and agriculture wastes.

It is yet another objective of the invention to convert lignocellulosic wastes to soil ameliorator enriched with easily accessible nutrients.

All the above objects are achieved by the invention described as improved anaerobic digestion system and its various embodiments.

Accordingly the invention provides an improved anaerobic digester for household organic wastes for generating stabilized compost of less water and obtaining methane rich biogas comprising a horizontal vessel of 300 to 2500 mm length (200-2500 litre), provided with insulation and preferably cylindrical at the end, fitted inside the said vessel at least one shaft with 4-100 radial or horizontal or diagonal baffles, preferably at equal distribution, and attached with a handle or wheel outside the vessel to rotate the shaft from outside, the said vessel being provided with minimum of one port of 50 to 500 mm diameter on one end for introducing the raw biomass wastes and another set of ports of 50 to 100 mm for discharging stabilized wastes on the opposite end, and having one valve-controlled gas port of 5 to 10 mm diameter above the level of the said port for discharging stabilized wastes, a small hand operated shredder of 250 to 1000 ml volume coupled to the digester vessel for shredding/cutting/crushing large and hard solids such as bones to get smaller particles preferably lesser than 10 mm sizes.

According to another embodiment of the invention, it provides a system to digest biomass wastes for generating stabilized compost of less water and obtaining methane rich biogas, the system comprising an anaerobic digester of 200-2500 litre, essentially a horizontal vessel of 300 to 2500 mm length, provided with insulation if needed and preferably cylindrical at the bottom, fitted inside the said vessel at least one shaft with 4-100 radial or horizontal or diagonal baffles at equal distribution preferably, and attached with a handle or wheel outside the vessel to rotate the shaft from outside, the said vessel being provided with minimum of one port of 50 to 500 mm diameter on one end for introducing the raw biomass wastes and another set of ports of 50 to 100 mm for discharging stabilized wastes on the opposite end, and having one valve-controlled gas port of 5 to 10 mm diameter above the level of the said port for discharging stabilized wastes.

According to a feature of the invention, the inlet and outlet ports are fitted on the opposite ends of the digester with the baffled shaft inside the vessel.

It is an important feature of the invention that the digester and/or shredder is/are made of materials compatible to anaerobic treatment of biomass wastes such as steel, fibre reinforced polymers, plastic, concrete, etc. or their combinations.

According to yet another feature of the invention, the initial anaerobic population in digester is created by filling biologically stabilized moist organic compost or discharges of biogas plant possessing rich anaerobic microbial flora and adding minimum fresh water, if needed, to form a slurry of 20-40% total solids. The initial anaerobic population has facultative bacteria, anaerobic bacteria, fungi, protozoa, and actinomycetes in their natural active forms or as dormant spores or isolated forms.

According to another feature of the invention that the shaft is rotated few times on feeding raw biomass wastes every time, that ensures mixing of the wastes inside, enhancing the rate of biodegradation that include disintegration of the large pieces of biomass to smaller particles, decomposition of the particles to soluble compounds, compounds to molecules, to volatile fatty acids such as acetate and leading to biomethanation.

According to another feature of the invention that the rotation of the shaft few times on feeding, releases biogas from digestion and eases the movement of material forward from feed port.

According to another feature of the invention that the biodegradation and biomethanation above the freezing temperature are facilitated on fed wastes that include food wastes containing vegetables, rice, cereals, meats, egg yolk, spoiled milk or its preparations and sweets, vegetable peelings, vegetable cuttings, fruit peels, rotten food, fruits and vegetables, by the growth of microbial population in the digester resulted through hydrolysis, acidogenesis, acetogenesis and biomethanation.

According to the preferred embodiment of the invention that the shredding of wastes materials is performed to result faster digestion and stabilization of the wastes in the case of particularly hard materials like bones and seeds or sizes of beyond 2-3 centimetres, followed by feeding to the port and gentle mixing for a minute by the help of a handle provided where a mixed population of microorganisms in decaying biomass, that enables material hydrolysis, decomposition, acidogenesis, acetogenesis and biomethanation to produce methane rich biogas and nutrient rich compost for agriculture applications.

According to the preferred embodiment of the invention that the anaerobic process of digestion and biomethanation is optimally operated at mesophilic to thermophilc temperature conditions as the rate would fall <20° C. and >55° C. and that is controlled with proper insulation, heating or cooling of the digester as per any standard known techniques where the environmental temperatures are extreme naturally.

According to the preferred embodiment of the invention that the system is operated and worked in and around neutral pH conditions of 6.8 to 9.0 automatically, without buffering through extra addition of acid or alkali.

It is an important feature of the invention that the digested discharge possesses total solids of 9-40%.

These and other objects, features and advantages of the invention will become more clearly apparent from the following description of the embodiments of the invention given as a non-restrictive example only.

### BRIEF DESCRIPTION OF THE DRAWINGS

The following drawings are part of the present specification and are included further to describe the invention. The invention may be better understood by referring to them singly or in combination with the detailed description of the specific embodiments presented herein.

FIG. 1 is a schematic drawing of an embodiment of the compact anaerobic digestion system of the present invention.

FIG. 2 is a schematic drawing of portions of the system shown in FIG. 1, which shows the direct feed port, shredder feeder port and the baffles on the mixing device.

FIG. 2b is a schematic sectional view of shredder feeder of the system shown in FIG. 1.

### DETAILED DESCRIPTION OF THE INVENTION

The preferred embodiments of the invention are discussed in detail below. While specific steps, configurations and arrangements are discussed, it should be understood that this is done for illustrative purpose only. A person skilled in the art will recognize that other steps, configurations, plurality and arrangements can be used without departing from the spirit and scope of the present invention. While the foregoing description assumed a particular embodiment it will be appreciated that the present invention may be used in numerous other embodiments and other examples.

The present invention may include improved system for anaerobic digestion of biomass wastes for generating methane rich biogas, enabling release of bound nutrients and stabilization of wastes in less water for agriculture soil applications. Accordingly the preferred embodiment of the invention of system to feed biodegradable wastes, particularly of household origin such as food wastes, kitchen wastes, agriculture residues, etc, of different sizes, nature and moisture content. The system includes known and unknown features in combinations to provide improved, efficient and suitable for the anaerobic digestion of wastes biomass especially at the source of generation like houses. The system is designed to perform anaerobic digestion in less moisture to have high retention for complete degradation in small volume and to avoid use of additional water and generating concentrated compost for easy handling and transportation.

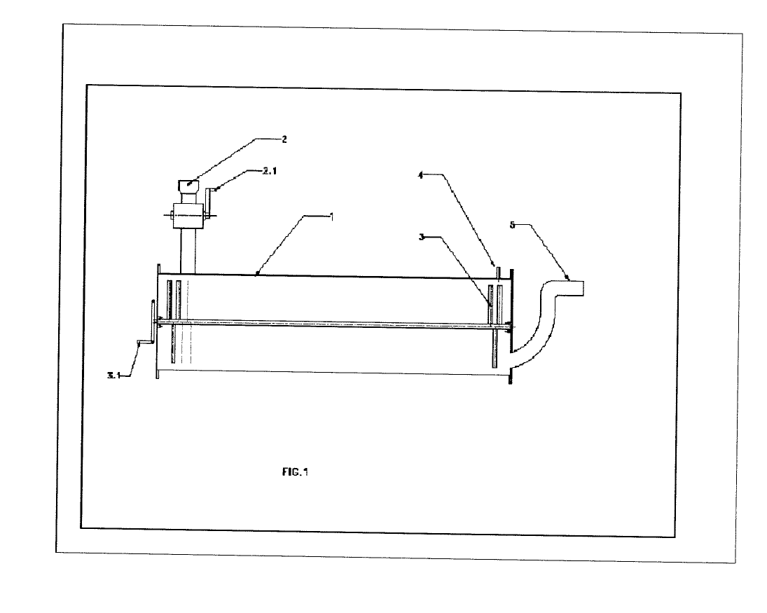

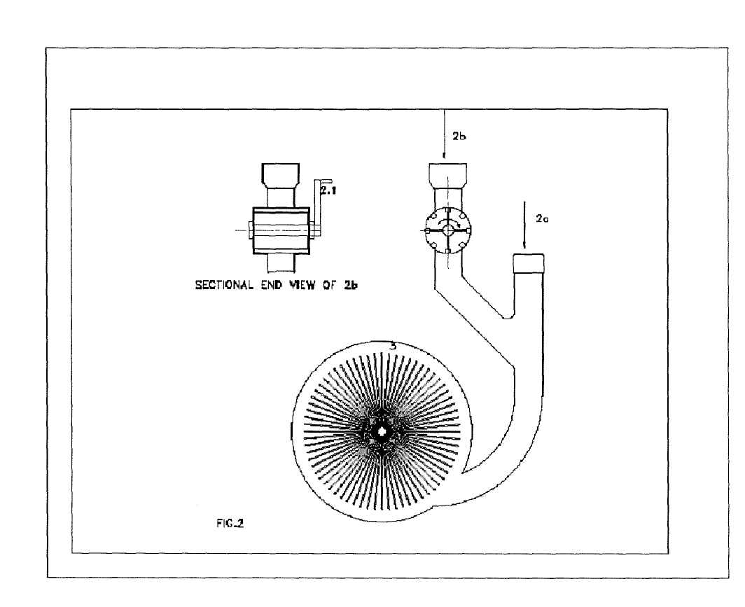

FIG. 1 is a schematic of an embodiment of the improved anaerobic digestion system according to invention, and FIG. 2 includes diagrams of feed port with and without shredder and an over view of baffles on the shaft from feeding side which represent the following features: a horizontally fabricated closed vessel (1) for anaerobic digestion of waste biomass, provided with waste biomass introducing port (2) and a rotating handle (2.1) attached to it (2), a gas release port (4) and composted material discharge port (5), and also provided with facility for mixing the material inside from outside by the help of a handle (3.1) fixed to a shaft of appropriate configurations in the digester vessel using the state of art mechanical fixtures such as bearing or bush, on which baffles (3) or similar fixtures arranged radially or horizontally or diagonally or in any other pattern that imparts effective stirring of the material inside and to work in the movement of particles, microorganisms, enzymes, moisture, and release of gases, and improve the flow of material towards the discharge port slowly.

The port or ports for the feed is made in such way that the feed material can be loaded conveniently and preventing biogas leak, and which can receive feeds of varied characteristics like, slurry, powder, ground or shredded wastes, and fitting proper lids or valves to control falling of water from outside. Discharge port or ports can be of the choice that permit passage of digested waste material easily and without interfering the functions including biogas collection and without leaks, preventing entry of air to the digester vessel and water from outside, may be followed by a suitable bin to collect the stabilized sludge for further to use as soil manure. In the bin materials like saw dust, peat or coir peat is provided to absorb moisture in the digested material for easy handling and soil applications. Biogas produced and collected in the apparatus is released through a valve regulated port which can be of a standard make available or specially fabricated and having suitable internal diameter, may be not less than 5 mm for the purpose provided on top of the vessel where the biogas is collected continuously during the process and stored. Extra storing of the biogas for can be possible in the vessel itself with the provision of large volume and/or with additional biogas storage systems available and connecting to the valve controlled biogas port of the anaerobic system.

The waste biomass feed include kitchen wastes—cooked and uncooked food materials, spoilt foods, animal and plant derived tissues, egg shells and yolk, garden wastes, waste paper, fruits, fruit peelings, animal wastes that contain one or more components like carbohydrates, proteins and fats in simple or complex forms which can be transformed or converted to methane and easily utilizable nutrients like compost for agriculture applications.

Extra moisture is not added in the system during or after feeding the wastes and the waste biomass is added directly, and hard biomaterials are preferred to be shredded or ground for reducing the particle size to less than 10 mm preferably to ease the operation using the attached hand shredder or any standard system and no need to make a slurry which can also be fed.

Pre loading of horizontal digester is done with the anaerobically digested or partially digested material obtained from a standard domestic biogas plant or digester that contain biologically stabilized moist organic compost possessing rich anaerobic microbial flora of bacteria, fungi, protozoa, and actinomycetes in their natural active forms or as dormant spores or isolated forms, and adding minimum fresh water, if needed to form a slurry of 20-40% total solids.

Typical kinds of microbes useful in the anaerobic digester of the invention include eubacteria, archea, yeast, protozoa, fungi and actinomycetes and the usual organisms among involved are Proteus sp. Salmonella sp., Aerobacter sp. Escherichia coli, B. subtilis, Bacillus sp., Micrococcus, Sytrophobacter, Syntrophomonas, Bacteroides, Leptonema, Butyrivibrio, Clostridium sp., Lacteriodes, Ruminococcus, Peptococcus, Lactobacillus, Methanobacterium, Methanococcus, Methanobacillus, Methanosarcina, Methanothrix sp. Desulfovibrio, and during their growth both independent syntrophic enable decomposition of biomass and resulting to biogas production.

The wastes biomass is added to the system through the feed port (2a) directly or after shredding (2b) wherein materials fed are cut into smaller sizes on rotating the handle attached (2.1), followed by mixing through rotating the handle of the of the anaerobic digester where a mixed population of microorganisms in decaying biomass act upon, that enables material hydrolysis, decomposition, acidogenesis, acetogensis and biomethanation and producing methane rich biogas and nutrient rich compost for agriculture applications. The anaerobic process of digestion and biomethanation can be optimally operated at mesophilic to thermophilc temperatures and the rate would fall <20° C. and >55° C. and that can be controlled with proper insulation, heating or cooling of the digester as per any standard known technique. The system can be operated and worked in and around neutral pH conditions ranging from 6.8 to 9.0 that is maintained automatically in the system, without buffering through extra addition of chemicals, acid or alkali.

The anaerobic digestion of wastes materials is performed by feeding material length <25 cm, width of <10 cm and thickness <3 cm except hard bones, resulting complete and fast digestion, and received stabilized discharge consistently, in addition to waste biomass as slurry or powder.

Biogas generated out of anaerobic digestion is released through the gas port which is controlled by a valve, on the top of the system and this can be connected directly to a burner or after storage for heating purpose or to any standard power generation after purification systems, if required to meet specifications of the burner/power generator. The rate of biogas production is varied from 250 litre/day to 2500 litres/day where the feeding of the waste is varied from 120 gm to 1 kg dry weight, and wherein the original moisture content is between 40% to 95% depending on the kind of wastes and modifications occurred. The volatile fatty acid (VFA) content in the discharge is reduced to mg level which is usually more than hundred times in the domestic biogas plants. As a result higher conversion of the VFA to methane is achieved and the digested material is free of decaying smell. The biogas generated in the system is composed mainly of methane, >75% and carbon dioxide <25%, and the content of hydrogen sulphide is in traces as the pH of the material in the process is maintained around 8.0 or above where partitioning of free H₂S is much lesser than pH 7.0 or below, usually the condition of operation resulted in high water and domestic biogas plants.

Highest level of digestion is resulted in the mechanism, even the poor degradable fats of the wastes which is fed in the range of 0.1% to 50%, being degraded and ultimately converted to biogas product, and retained practically very little or no free fats in the digested discharge as it is measured as 50-250 mg/kg dry matter, accounted to mainly the fats of the microbial cells. The gas production rate (volume of biogas produced per day/volume of digester) is 1.0 or above which is more than double of the existing models.

The solids in the anaerobic digestion system is varied from 7 to 40% dry weight, preferably about 15 to 40% dry weight, based on the moisture in the feed.

The consistency of the discharge is usually thick and brownish black slurry with the total solids in the range 9 to 40%, and that would change on feed moisture and can be 5 to 60% upon feeding waste of highly varied moisture. Relative particle sizes in the discharge is ranged below 0.2 cm and longer particles would appear in case large fibrous and bones are fed without shredding. Higher level of biodegradation is due to the less water anaerobic digestion that enhances retention period for the wastes to effect higher concentrations of the biological reagents and complete digestion of the wastes. The degradation of the biomass wastes is measured in higher degree as the volatile solids of feed waste substantially removed in the mechanism and where many polymeric materials like cellulosic content is also decomposed by the microbial activities.

### Example

### Anaerobic digestion of Kitchen Wastes

This process was conducted in 350 litre capacity anaerobic digester and feeding kitchen wastes everyday that consisted of vegetable peelings, fish dressing wastes, rotten fruits, cooked food having rice, vegetables, chicken meat, sweets, mouldy bread and biscuits, egg yolks, egg shells, fruit peels, fats, chicken bones in varying ratio each day, garden grass and leaves, and weighed altogether from about 500 gm to 1500 gm.

Feed composition of a day is the following where total wet weight is 503.66 gm and dry solids 116.94 gm (Total Solids content 23.22%).

| Materials | Fresh Weight gm | Dry Solids gm |
|---|---|---|
| Egg yolk | 17.96 | 7.41 |
| Orange peel | 21.34 | 5.11 |
| Lichi fruit peel | 33.55 | 7.42 |
| Beetroot peel | 22.19 | 3.08 |
| Tomato | 12.84 | 3.14 |
| Coconut kernel | 22.15 | 3.03 |
| Potato peel | 45.20 | 7.51 |
| Banana | 128.87 | 28.71 |
| Fish bone and residues | 28.44 | 12.07 |
| Cucumber peel cuttings | 10.45 | 6.7 |
| Onion peels | 7.15 | 1.92 |
| Brinjal | 15.17 | 1.84 |
| Drumstick | 20.35 | 7.73 |
| Vegetable curry | 118 | 21.27 |

The digester was initially loaded with 15 kg cow dung having moisture content of 55% and 15 kg discharge from a kitchen wastes biogas plant (conventional less solids type) with moisture content of 96%, and it was maintained in the atmospheric temperature of 25° C. to 30° C. for 15 days prior to the addition of fresh wastes from a family kitchen. The values included are after the continuous operation of the system for four months and establishing stable performance by feeding the kitchen wastes and maintaining at the atmospheric temperature condition of 22° C. to 30° C. Average biogas production from system is more than 400 litres/day and the methane content of the biogas is more than 75%. The digested discharge had pH ranging from 7.9 to 8.3, about 9.7% to 20.8% dry solids. The extractable fat in the discharge is 60 mg/kg dry weight when the anaerobic digester was feeding total fat of 5 to 20% level.

### ADVANTAGES OF INVENTION

This invention effects safe disposal of household biodegradable wastes, utilization of waste biodegradables, conversion of wastes materials to stable compost, utilization of inert lignocellulosic wastes for steady release of nutrients, increased retention of moisture in soil, crop plants, and application of the material to provide better aeration and preventing compaction of soil which facilitates improved agriculture. This invention avoids use of extra water for anaerobic digestion as required in the routinely used domestic biogas plants worldwide. This invention equips nutrients recovery and their utilization at the source of wastes generation free of costs. This invention also enables easy handling, transportation and direct use of stabilized compost conveniently. This invention finds effective utilization of lingocellulosic wastes in soil amelioration. This invention also facilitates conversion of stored carbon in the organic materials to generate methane and its collection and direct use for fuel purposes at the source, which avoids storage/transportation costs or emission hazard. This invention leads to decentralized processing of biodegradable wastes that can avoid difficulty in collection, multilevel segregation, emission hazards in transportation and handling areas, and reduces public burdens on centralized treatments.

The present digester is compact (⅓rd smaller in size compared to the existing commercial models and therefore cost savings on fabrication and requires less footprint), free of pollution and mosquito breeding from discharges (complete solution to waste management), biogas contains higher (more than 75% methane) and less carbon dioxide (less than 25%) that results in higher fuel efficiency, less volume discharge around 1 kg (easy to store for specific compost applications) compared to more than 10 litres of the commercial models. In addition to the above the present digester could decompose all biodegradable wastes unlike in the existing household biogas plants.

1. An improved anaerobic digester for household organic wastes for generating stabilized compost of less water and obtaining methane rich biogas comprising a horizontal vessel provided with insulation and preferably cylindrical at the end of the vessel, fitted inside the said vessel at least one shaft with 4-100 radial or horizontal or diagonal baffles at equal distribution, and attached with a handle or wheel outside the vessel to rotate the shaft from outside, the said vessel being provided with a port of 50 to 500 mm diameter at one end for introducing the raw biomass wastes and another set of ports of 50 to 100 mm diameter for discharging stabilized wastes on the opposite end, and having one valve-controlled gas port of 5 to 10 mm diameter above the level of the said port for discharging stabilized wastes, a small hand operated shredder of 250 to 1000 ml volume is being coupled to the digester vessel for shredding/cutting/crushing large and hard solids which is being attached to inlet port.

2. An improved anaerobic digester as claimed in claim 1 wherein the said digester is schematically represented by figures provided herewith which comprises a horizontally fabricated closed vessel for anaerobic digestion of waste biomass, provided with a waste biomass feed port or inlet port, gas release port and composted material discharge port or outlet port, and also provided with facility for mixing the material inside by the help of a handle fixed to a shaft of appropriate configurations using the mechanical fixtures such as bearing or bush, on which baffles or similar fixtures arranged radially or horizontally or diagonally or in any other pattern that imparts effective stirring of the material inside and to facilitate the movement of particles, microorganisms, enzymes, moisture, and release of gases, and to improve the flow of material towards the discharge port slowly, the feed port of said digester is being also provided with a rotating handle to facilitate shredding/cutting/crushing of organic waste and feed is being introduced either through after shredding, or directly through without shredding.

3. An improved anaerobic digester as claimed in claim 2 wherein the inlet port and outlet ports are fitted on the opposite ends of the digester with the baffled shaft inside the vessel which is meant for stirring the waste material inside the digester.

4. An improved anaerobic digester as claimed in claim 1 wherein the handle attached to inlet port is meant for cutting the fed material into smaller sizes and the rotating the handle is meant for mixing and slow movement of the fed material through the digester where a mixed population of microorganisms act upon decaying biomass, that enables hydrolysis, decomposition, acidogenesis, acetogensis and biomethanation of the fed waste biomass.

5. An improved anaerobic digester as claimed in claim 1 wherein the digester and/or shredder is/are made of materials compatible to anaerobic treatment of biomass wastes, wherein the said material is steel, fibre reinforced polymers, plastic, concrete, or combinations thereof.

6. An improved anaerobic digester as claimed in claim 1 wherein biogas generated in the system is composed mainly of methane, >75% and carbon dioxide <25% and gas production rate (volume of gas produced per day/volume of digester) is 1.0 or above.

7. An improved anaerobic digester as claimed in claim 1 wherein the waste solids produced in the anaerobic digestion system is varied from 7 to 40% dry weight, preferably about 15 to 40% dry weight, based on the moisture in the feed and the volume discharge is around 1 kg/day.

8. An improved anaerobic digestion process using the anaerobic digester as claimed in claim 1 comprising the steps of:
feeding biodegradable waste in the anaerobic digester;
conducting anaerobic process of digestion and biomethanation optimally at mesophilic to thermophilic temperature conditions to generate biogas and discharge waste solids.

9. An improved anaerobic digestion process as claimed in claim 7, wherein the anaerobic process of digestion and biomethanation is optimally operated at mesophilic to thermophilic temperature conditions at a temperature ranging <20° C. and >55° C. that is controlled with proper insulation of the horizontal vessel.

10. An improved anaerobic digestion process as claimed in claim 8, wherein anaerobic process of digestion and biomethanation is conducted using microbes selected from eubacteria, archea, yeast, protozoa, fungi and actinomycetes and the usual organisms among involved are Proteus sp. Salmonella sp., Aerobacter sp. Escherichia coli, B. subtilis, Bacillus sp., Micrococcus, Sytrophobacter, Syntrophomonas, Bacteroides, Leptonema, Butyrivibrio, Clostridium sp., Lacteriodes, Ruminococcus, Peptococcus, Lactobacillus, Methanobacterium, Methanococcus, Methanobacillus, Methanosarcina, Methanothrix sp. Desulfovibrio.

11. An improved anaerobic digestion process as claimed in claim 8, wherein biodegradation is conducted under minimum water condition and no requirement of electricity to generate biogas.

12. An improved anaerobic digestion process as claimed in claim 8, wherein the said process is conducted at around neutral pH condition of 6.8-9 automatically, without buffering through extra addition of acid or alkali.

13. An improved anaerobic digester as claimed in claim 1, wherein waste is selected from household waste materials consisting of vegetable peelings, fish dressing wastes, rotten fruits, cooked food having rice, vegetables, chicken meat, sweets, mouldy bread and biscuits, egg yolks, egg shells, fruit peels, fats, chicken bones, garden grass and leaves in varying ratio.

14. An improved anaerobic digester for household organic waste as described herein with reference to drawings accompanying the specification.
